(19) United States
(12) Patent Application Publication
(10) Pub. No.: US 2026/0102839 A1
(43) Pub. Date: Apr. 16, 2026

(54) METHOD AND DEVICE FOR SPOT WELDING

(71) Applicants: Hyundai Motor Company, Seoul (KR); Kia Corporation, Seoul (KR)

(72) Inventor: Seung Ho Lee, Gyeonggi-do (KR)

(21) Appl. No.: 19/186,206

(22) Filed: Apr. 22, 2025

(30) Foreign Application Priority Data
Oct. 15, 2024 (KR) 10-2024-0139916

(51) Int. Cl. B23K 11/11

(52) U.S. Cl. CPC B23K 11/115

(57) ABSTRACT

A method for spot welding includes applying preset welding heat input to a welding device in correspondence to a welding base material positioned at the welding device by a controller, applying the preset welding heat input to the welding position by moving the welding device by the controller, measuring height variation of the applied welding position through an encoder, and providing target heat input by compensation for a current value that is applied to the welding position by comparing real-time height variation of the welding position measured through the encoder and a gradient set in the controller.

### CROSS REFERENCE TO RELATED APPLICATION

The present application claims under 35 U.S.C. § 119(a) the benefit of Korean Patent Applications No. 10-2024-0139916, filed on Oct. 15, 2024, the entire contents of which are incorporated by reference herein.

### BACKGROUND

### (a) Technical Field

The present disclosure relates to a method and device for spot welding, more particularly, to the method and device for spot welding in which an optimum welding heat input is calculated and the quality of a final welded product is determined by comparing the calculated optimum welding heat input with the actual applied heat input.

### (b) Description of the Related Art

In general, resistance spot welding is a welding method that applies a current with welding target materials pressed with a welding electrode and joins the materials by melting them using resistance heating that is generated in this process. Resistance is dynamically changed by the correlation between a phenomenon in which resistance is increased by an increase in temperature of a base due to resistance heating that is generated when a welding current passes through a material a phenomenon in which resistance is decreased by an increase of a current conduction cross-sectional area due to growth of nuggets that are formed by melting of a base material. This is called dynamic resistance.

Further, currently, various methods are used to inspect the quality of spot resistance welding using equipment, including a method of inspecting quality by analyzing the size of a nugget diameter using ultrasonic waveforms in offline mode and a method of estimating strength quality by measuring a weld indentation depth. However, it is difficult to secure reliable data due to external conditions that change in welding, so there is no reliable weld quality inspection being performed. Further, in most case, since inspection methods are not conducted in real time but rather through offline sample testing, there is a problem that could lead to large-scale resistance spot welding quality defects.

Accordingly, the demand for welding equipment that can accurately calculate welding heat input, which is applied to a welding position, and can automatically adjust welding conditions continues to persist.

### SUMMARY

The present disclosure is configured to measure the distance between electrodes of welding devices through an encoder and provide an optimum welding heat input using the measured distance.

Another objective of the present disclosure is to provide a method and device for spot welding for determining a welding result with normal quality by measuring a nugget formation completion time after welding is finished.

The objectives of the present disclosure are not limited to those described above and other objectives not stated herein may be understood through the following description and may be clear by embodiments of the present disclosure. Further, the objectives of the present disclosure will be achieved by the configurations described in claims and combinations thereof.

A method and device for spot welding for achieving the objectives of the present disclosure includes the following configuration.

According to an aspect of the present disclosure, a method for spot welding includes steps of: applying, by a controller, a preset welding heat input to a welding device; applying, by the controller, the preset welding heat input to a welding position by moving the welding device; measuring, by an encoder, a height variation of the applied welding position; calculating, by the controller, an optimum target heat input by comparing a real-time height variation of the welding position measured through the encoder and a gradient set in the controller; and determining, by the controller, weld quality by comparing the calculated optimum target heat input and an actual welding heat input.

The controller may apply the preset welding heat input in correspondence to a welding base material positioned at the welding device.

The controller may calculate the optimum target heat input by compensating for a current value that is applied to the welding position.

As another aspect, the method for spot welding includes: applying preset welding heat input to a welding device in correspondence to a welding base material positioned at the welding device by a controller; applying the preset welding heat input to the welding position by moving the welding device by the controller; measuring height variation of the applied welding position through an encoder; and providing target heat input by compensation for a current value that is applied to the welding position by comparing real-time height variation of the welding position measured through the encoder and a gradient set in the controller.

Further, in the applying of preset welding heat input to a welding device in correspondence to a welding base material positioned at the welding device by a controller, the preset welding heat input may be calculated on the basis of existing data stored in accordance with completion of welding.

Further, in the providing of target heat input by compensation for a current value that is applied to the welding position by comparing height variation of the welding position measured through the encoder and a gradient set in the controller, the method may include: determining whether a height variation gradient of the welding position is larger than a set gradient without spatter; increasing a current value that is applied to the welding device when the height variation gradient of the welding position is larger than the set gradient without spatter; determining whether the eight variation gradient of the welding position is a set gradient with spatter in accordance with the increased current value; and setting welding heat input including a first margin value in the increased current value when the height variation gradient of the welding point is the set gradient with spatter or less.

Further, in the providing of target heat input by compensation for a current value that is applied to the welding position by comparing height variation of the welding position measured through the encoder and a gradient set in the controller, the method may include: determining whether a height variation gradient of the welding position is a set gradient with spatter or less; decreasing a current value that is applied to the welding device when the height variation gradient of the welding position is a set gradient with spatter or less; determining whether height variation of the welding position is larger than a set gradient without spatter in accordance with the decreased current value; and setting welding heat input including a second margin value in the decreased current value when the height variation of the welding position is larger than a set gradient.

Further, in the compensating of a current value that is applied to the welding position by comparing height variation of the welding position measured through the encoder and a gradient set in the controller, the method may further include: evaluating a weld quality state to which the compensated current value is applied, by the controller.

Further, in the evaluating of a weld quality state to which the compensated current value is applied, by the controller, the method may include: measuring height variation of the welding position during welding through the encoder; measuring a formation completion time of nuggets in correspondence to a position where the measured height variation of the welding position is maximum; and calculating actually applied heat input on the basis of the measured formation completion time of nuggets.

Further, in the calculating of actually applied heat input on the basis of the measured formation completion time of nuggets, the method may include: calculating heat input actually applied to the welding position on the basis of welding dynamic resistance, a current that is applied to the welding device, and the formation completion time of nuggets that are calculated on the basis of a voltage and a voltage drop amount detected in welding; determining whether the actually applied heat input is within a normal range; and determining poor quality when the actually applied heat input is out of the normal range.

Further, in the calculating of actual welding heat input on the basis of the measured formation completion time of nuggets, the method may include calculating actual welding heat input applied to the welding device by performing a definite integral of an applied current and calculated dynamic resistance on the basis of the formation completion time of nuggets by the controller.

Further, in the providing of target heat input by compensation for a current value that is applied to the welding position by comparing height variation of the welding position measured through the encoder and a gradient set in the controller, the gradient may be set through a machine learning algorithm of an analysis processor.

Further, in the providing of target heat input by compensation for a current value that is applied to the welding position by comparing height variation of the welding position measured through the encoder and a gradient set in the controller, the method may include storing a β peak value of calculated dynamic resistance and the calculated target heat input in the controller.

According to a further aspect of the present disclosure, a device for spot welding includes: a welding device; a controller configured to apply a preset welding heat input to the welding device and at a welding position by moving the welding device; and an encoder configured to measure a height variation of the applied welding position; wherein the controller is configured to calculate an optimum target heat input by comparing a real-time height variation of the welding position measured through the encoder and a gradient set in the controller; and wherein the controller is configured to determine a weld quality by comparing the calculated optimum target heat input and an actual welding heat input.

In the device, the controller may apply the preset welding heat input in correspondence to a welding base material positioned at the welding device.

In the device, the controller may calculate the optimum target heat input by compensating for a current value that is applied to the welding position.

According to the present disclosure, it is possible to achieve the following effects from the configuration, combination, and operation relationship to be described below.

The present disclosure has an effect of providing an effective method for spot welding by calculating optimal heat input according to a real-time distance variation amount between electrodes of a welding device on the basis of heat input that is initially applied to the welding device.

Further, present disclosure has an effect of providing an effective method for spot welding that can minimize a defect rate because it is possible to determine the quality of finished welding by comparing actually applied heat input and calculated target heat input on the basis of nugget formation completion time at the point of time when welding is finished.

### BRIEF DESCRIPTION OF THE DRAWINGS

FIG. 1 shows a configuration diagram of a welding device as an embodiment of the present disclosure;

FIG. 2 shows a flowchart of a method for spot welding as an embodiment of the present disclosure;

FIG. 3 shows a flowchart of an optimum welding condition algorithm of a method for spot welding as an embodiment of the present disclosure;

FIG. 4A shows height-time data when normal welding is performed as an embodiment of the present disclosure;

FIG. 4B shows height-time data when abnormal welding is performed as an embodiment of the present disclosure;

FIG. 5 shows heat input data when normal welding is performed as an embodiment of the present disclosure; and

FIG. 6 shows data for calculating heat input, which is actually applied, to determine weld quality.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, embodiments of the present disclosure will be described in detail with reference to the accompanying drawings. Embodiments of the present disclosure may be modified in various ways and the scope of the present disclosure should not be construed as being limited to the embodiments to be described below. The embodiments are provided to more completely explain the present disclosure to those skilled in the art.

Terms used in the present disclosure are used only in order to describe specific exemplary embodiments rather than limiting embodiments. Singular forms are intended to include plural forms unless the context clearly indicates otherwise.

Some components are given terms “first”, “second”, etc. for discrimination throughout the specification because they have the same names, but they are not necessarily limited to the order in the following description.

Further, in the specification, various embodiments may be implemented as software (e.g., programs) including commands stored in machine (e.g., computer)-readable storage media. The machine, which is a device that can call for stored commands from a storage medium and can operate in accordance with the called commands, may include electronic devices (e.g., server) according to the embodiments described herein. The commands may include codes that are created or executed by a compiler or an interpreter. The machine-readable storage media may be provided in a non-transitory storage medium type. The term “non-transitory” means that a storage medium does not include a signal and is tangible and also it does not consider whether data is semi-permanently or temporarily stored in a storage medium.

Further, according to an embodiment of the present disclosure, a method according to various embodiments disclosed herein may be included in a computer program product. The computer program product may be traded between a seller and a purchaser as an item. The computer program product may be distributed in the type of a device-readable storage medium (e.g., a Compact Disc Read Only Memory (CD-ROM) or through an application store (e.g., Play Store™) on the web. When the computer program product is distributed on the web, at least a portion of the computer program product may be at least temporarily stored or created in a storage medium such as the memory of the server of the manufacturer, the server of an application store, or a relay server.

Hereinafter, embodiments are described in detail with reference to accompanying drawings, and in the following description of the accompanying drawings, like reference numerals are given to like components and repetitive description is omitted.

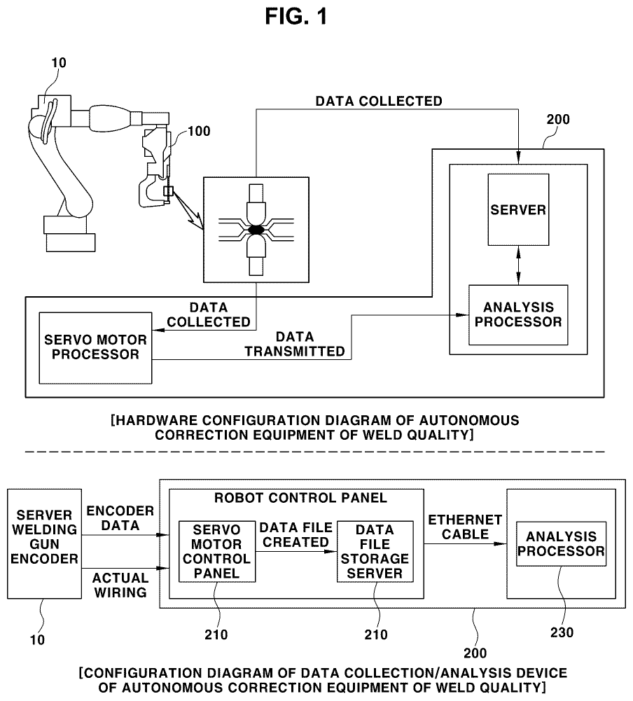

FIG. 1 shows a configuration diagram for performing spot welding as an embodiment of the present disclosure.

The present disclosure relates to a method for spot welding, which includes a welding device 10 that performs welding and a welding target base material that is placed on the welding device 10, and includes a controller 200 that can calculate and store dynamic resistance that is generated welding and a current that is applied to the welding device 10, optimum target heat input, actual welding heat input that is applied in real time to the welding device, nugget generation completion time, etc.

The controller 200 includes a servo motor control processor 210 that can control a servo motor of a robot arm constituting the welding device 10, a data file storage server 220 that can store a current and a voltage that are applied through the welding device 10, distance data between both electrodes of the welding device, a nugget formation completion time, etc. through an encoder 100 positioned in the welding device 100, and an analysis processor 230 that can calculate optimum target heat input that is applied to the welding device 10 on the basis of a distance variation gradient of the encoder 100.

The analysis processor 230 includes an algorithm that perform machine learning through data such as a distance gradient between electrode that is measured by the encoder 100, real-time applied heat input according to a nugget formation completion time, and target heat input.

In the present disclosure, resistance is dynamically changed by the correlation between a phenomenon in which resistance is increased by an increase in temperature of a base due to resistance heating that is generated when a welding current passes through a material a phenomenon in which resistance is decreased by an increase of a current conduction cross-sectional area due to growth of nuggets that are formed by melting of a base material, and this is called dynamic resistance. Further, dynamic resistance is calculated from a current I and a voltage that are continuously measured while welding is performed.

In the dynamic resistance, the largest resistance value after a set welding time passes is set as a reference dynamic resistance beta peak Bref. The set welding time may be set as 20˜40 ms and the reference dynamic resistance beta peak Bref may be set as 220μΩ.

Further, as an embodiment of the present disclosure, it is possible to measure a formation completion time of nuggets through the encoder 100, it is possible to calculate dynamic resistance at each time point per unit time of the nugget formation completion time, and on the basis of them, it is possible to calculate actual welding heat input that is applied to the welding device 10 through definite integral over time.

A motor unit includes a servo motor for operating a robot. The servo motor is an actuator of the robot and is driven on the basis of control signals for operation of the robot of the welding device output from the controller 200.

Further, the motor unit may further include a Proportional Integrate Derivative (PID) filter unit and pulse generator. The PID filter unit may include a function of calculating actual rotation position information detected through the digital encoder 100 and compensation information according to robot operation control signals output from the controller 200. The pulse generator may include a function of generating a pulse signal in accordance with output of the PID filter unit.

The encoder 100 is provided for each of axis-specific servo motors of the robot and includes a function of linking the motor unit and the robot operation controller 200. The encoder 100 can detect a digital encoder value that is a pulse value per rotation from an output signal showing the actual position information when the servo motor operates. Further, the encoder 100 can serve to transmit the digital encoder value to the controller 200 using ZigBee wireless communication method. Further, the encoder 100 further includes a function of receiving robot operation control signals from the controller 200 through ZigBee wireless communication method.

At least one encoder 100 of the present disclosure may be positioned at a first electrode positioned at the upper portion of the robot arm of the welding device that performs welding, or at a second electrode positioned at the lower portion of the robot arm. Further, the encoder 100 can measure the distance between the first electrode and the second electrode, and in an embodiment of the present disclosure, it can measure and transmit thickness variation data of a welding position to the controller 200 in real time.

Further, the encoder 100 can measure height variation of a welding position in real time, and the height that is measured may be decreased by generation of spatter at the welding position. That is, due to generation of spatter, the distance between the first electrode and the second electrode decreases and a displacement gradient may be calculated as a negative value by the controller 200.

A welding position may include a predetermined area positioned between the first electrode and the second electrode and it is possible to perform welding with the first electrode in contact with a second side of a base material that is in contact with the second electrode by controlling the motor unit.

The heat input that is applied through the welding device 10 may include heat input set in advance in the controller 200 on the basis of a base material that is initially welded. The preset heat input is output through machine leaning of the analysis processor 230 on the basis of existing data after welding is finished for the same base material, and the output data can be stored in the data file storage server 220 of the controller 200. Accordingly, the controller 200 is configured to apply pre-stored heat input to the welding device 10 when input of the welding device 10 for the same base material is applied.

Further, when welding is performed, the analysis processor 230 of the controller 200 can calculate optimum target heat input on the basis of the applied heat input. The optimum target heat input may be set as a boundary value of a high heat-input region and a medium heat-input region on the basis of an actual lobe curve.

The controller 200 may include a servo motor processor 210 for controlling the robot arm of the welding device 10 and a data file storage server 220 that stores data measured through welding. The data file storage server 220 can store a current, a voltage, heat input, dynamic resistance, a nugget formation completion time, etc. during operation of the welding device 10, and the data stored in the server is transmitted to the analysis processor 230 to analyze weld quality. The analysis process 230 of the controller 200 can collect data for determining optimum heat input by performing machine learning, and can calculate a correction value for providing optimum heat input on the basis of a measured slope of a current-time graph. That is, the analysis processor 230 determines real-time optimum heat input for welding and reflects a correction value to heat input that is applied to the welding device 10 in correspondence to the determined heat input.

Further, the controller 200 includes a step of comparing the actually applied hat input and target heat input to determine the quality of the welding device 10 to which the target heat input is applied. The controller 200 can calculate real-time heat input by performing a definite integral of dynamic resistance and a current with respect to a nugget formation completion time, and can determine weld quality by comparing the calculated real-time heat input with the target heat input.

The controller 200 can be linked with the encoder 100 using wireless or wired communication method. The controller 200 has a central processing unit and can generate robot operation control signals for driving axis-specific servo motors for moving multiple axes of the robot. The robot operation control signals generated by the controller 200 are transmitted to the encoder 100 of each motor unit provided for a robot shaft through wired or wireless communication, whereby it is possible to drive the axis-specific servo motors in accordance with the robot operation control signals.

As for the encoder 100 that drives the servo motor in linkage with the controller 200, the encoder 100 detects a digital encoder value that is a pulse value per rotation from an output signal showing the actual position information when the servo motor operates. In this case, the encoder 100 can transmit the digital encoder values detected from axis-specific servo motors of the robot to the controller 200 using ZigBee wireless communication method.

Thereafter, the controller 200 receiving the digital encoder values generates a robot operation control signal for controlling the operation of the robot on the basis of the digital encoder values. The controller 200 generating the robot operation control signal transmits the robot operation control signal to the encoders 100 attached to the axis-specific servo motors through wireless communication.

Further, the encoders 100 receiving the robot operation control signal can actively drive the axis-specific servo motors of the robot through a processor disposed in a wireless communication module using the robot operation control signal.

In the present disclosure, the encoder 100 can perform control of robot operation and can measure and transmit the distance between the first electrode and the second electrode to the controller 200 in real time. In an embodiment of the present disclosure, the encoder 100 may be configured to have a transmission speed of 2 ms. Further, the distance between the first electrode and the second electrode that is measured through the encoder 100 can be transmitted to the analysis processor 230 through Ethernet communication. The analysis processor 230 is configured to calculate optimum welding heat input in accordance with a displacement gradient on the basis of a height variation amount received through the encoder 100 and is configured to compensate for actual heat input that is applied when welding is performed.

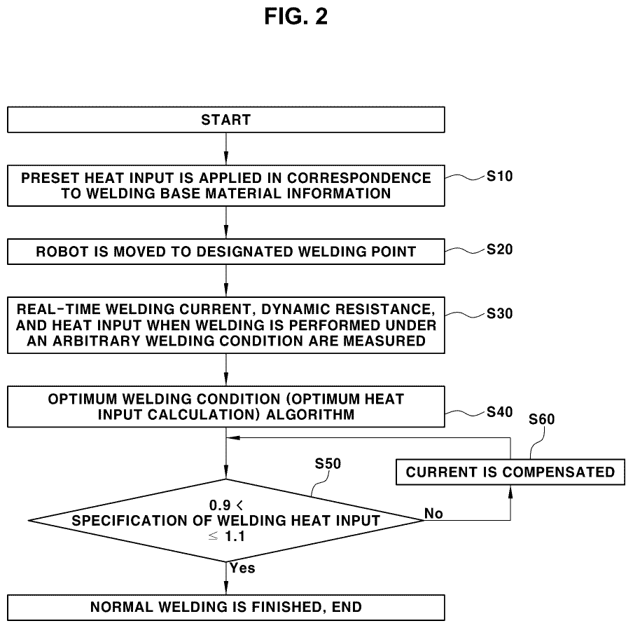

FIG. 2 shows a flowchart of a method for spot welding as an embodiment of the present disclosure.

First, the controller 200 applies preset weld heat input in the controller 200 to the welding device 100 in correspondence to a welding base material positioned at the welding device 10. In this case, the welding base material may be set in accordance with input from a user, and the preset welding heat input that is applied to the welding device 10 may be heat input stored in accordance with an existing welding step in the data file storage server 220 of the controller 200 (S10).

Further, the controller 200 is configured to apply the preset welding heat input by moving the first electrode or the second electrode of the welding device 10 (S20).

Thereafter, the method includes a step in which the controller 200 measures the height variation of the welding position in real time through the encoder 100 (S30). In this process, the encoder 100 measures displacement (height) of a welding point and the analysis processor 230 can determine the slope according to the displacement through the machine learning algorithm (S30).

Further, the controller 200 can receive the current, dynamic resistance, and actual welding heat input at a welding point in welding, and can store the data in the data file storage server 220.

Thereafter, the controller 200 provides target heat input by compensating for a current value that is applied to the welding position by comparing the real-time height variation of the welding position measured through the encoder 100 with a gradient set in the controller 200 (S40).

Thereafter, as a weld quality evaluation step, a step of determining whether the actually applied heat input is 90% to 110% of the target heat input (S50) is included, and when the actual welding heat input satisfies this condition, the corresponding welding is determined as normal. While welding is actually performed, the nugget formation completion time is measured through the encoder 100, and it is possible to calculate actual welding heat input by performing a definite integral of the dynamic resistance measured per unit time and the current value that is applied on the basis of the nugget formation completion time.

Further, it is determined whether the actual welding heat input that is applied to the welding device is 90% to 110% of the optimum target heat input (S50). Further, when the actual welding heat input is out of the range of 90% to 110% of the optimum target heat input, the controller sends out an alarm of poor welding and compensates for the current value such that the actual welding heat input is maintained in the range of 90% to 110% of the optimum target heat input. Accordingly, the normal quality range of welding is maintained.

It is possible to determine the quality of welding by comparing calculated target heat input and actual welding heat input in this way, and the controller 200 can send out an alarm of a problem of the welding device 10 or poor welding.

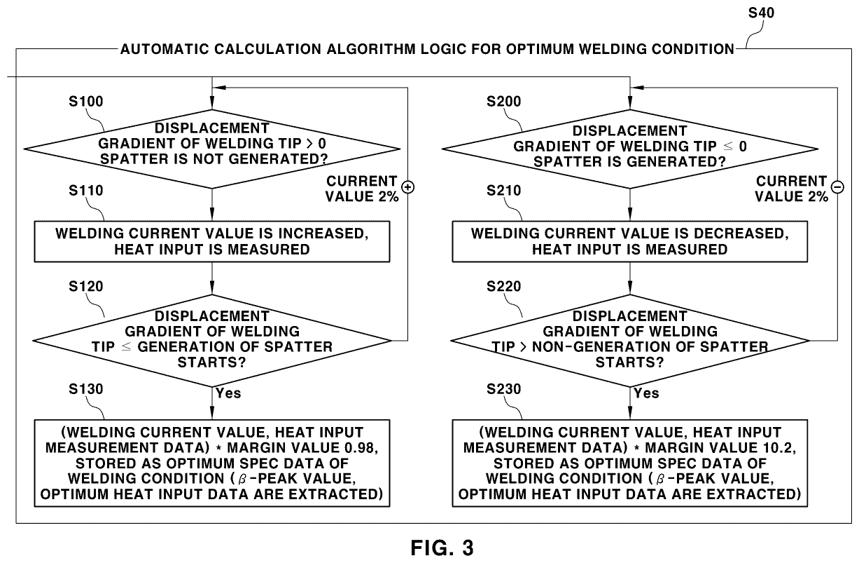

FIG. 3 shows a determination process of an optimum welding condition algorithm for calculating target heat input (S40) as an embodiment of the present disclosure.

The determination process of an optimum welding condition algorithm includes a process of calculating target heat input through the controller 200. That is, it is a step of providing target heat input by compensating for a current value that is applied to the welding device, in which a variation amount (gradient) of a height measured through the encoder 100 is determined.

The determination process includes a step of determining whether a height variation gradient of a welding position of the encoder 100 that is measured in real time is larger than a set gradient without spatter stored in advance in the controller 200 (S100).

When the height variation gradient of a welding position is larger than a set gradient without spatter, the current value that is applied to the welding device 10 is increased and the actually applied heat input is measured (S110). The determination process includes a step of determining whether the height variation gradient of the welding point measured by the encoder 100 in accordance with the increased current value is a set gradient with spatter or less (S120).

The determination process includes a step of setting welding heat input including a first margin value in the increased current value when the height variation gradient of the welding point is the set gradient with spatter or less (S130). As an embodiment of the present disclosure, the set gradient with spatter may be calculated as zero, and this is because the height variation of a base material when spatter starts to be generated changes to zero. Further, the first margin value may be set as 0.98 and this is for prevent the risk of generation of spatter from a base material when a current value corresponding to the set gradient with spatter is calculated as the actual welding heat input.

That is, when the welding device 10 has first a displacement gradient without spatter, the welding device 10 performs a step of calculating target heat input close to a gradient with spatter by increasing the applied current by 2 percent at a time, and of compensating for the target heat input with the actual welding heat input.

On the contrary, the controller 200 determines whether the height variation gradient of a welding position is a set gradient with spatter or less (S200). This means that the preset heat input that is initially applied is a spatter generation condition of a base material.

The determination process includes a step in which the controller 200 decreases the current value that is applied to the welding device 10 and calculates heat input when the height variation gradient of a welding position is a set gradient with spatter or less, the controller 200 (S210). The determination process includes a step of determining whether the height variation of the welding position is larger than a set gradient without spatter in accordance with the decreased current value (S220). In this case, a set gradient with spatter may be set as zero and can be determined on the basis of an inflection point where the height variation gradient initially calculated through the encoder 100 under a condition in which spatter is initially generated changes to zero. Accordingly, calculated heat input is determined on the condition that spatter is not generated.

The determination process includes a step of setting target heat input including a second margin value in the decreased current value when the height variation of the welding position is larger than a set gradient (S230). In this case, the second margin value may be set as 1.02 and the decreased current value may be a current decreased by 2 percent of the current that is currently applied in correspondence to determination.

The applied current value may be analyzed as the same concept as heat input.

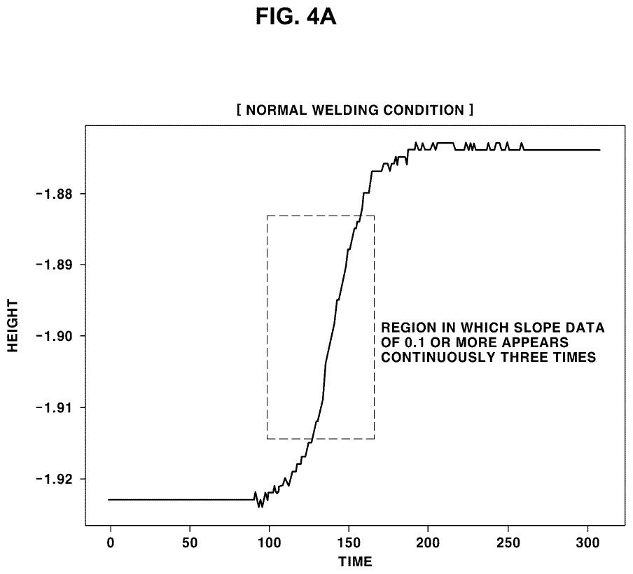

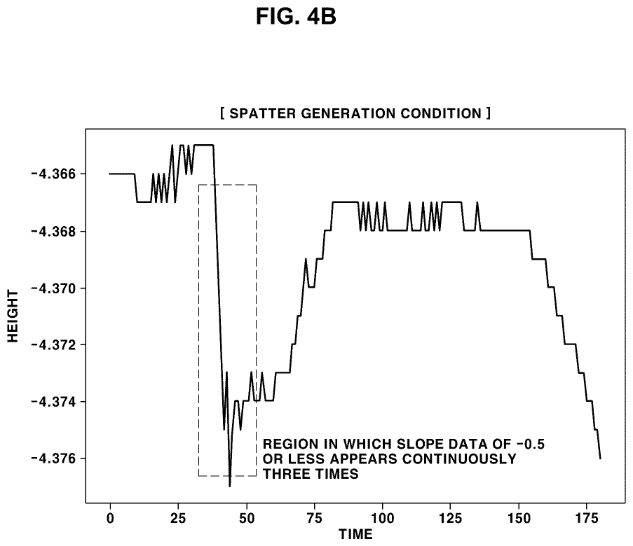

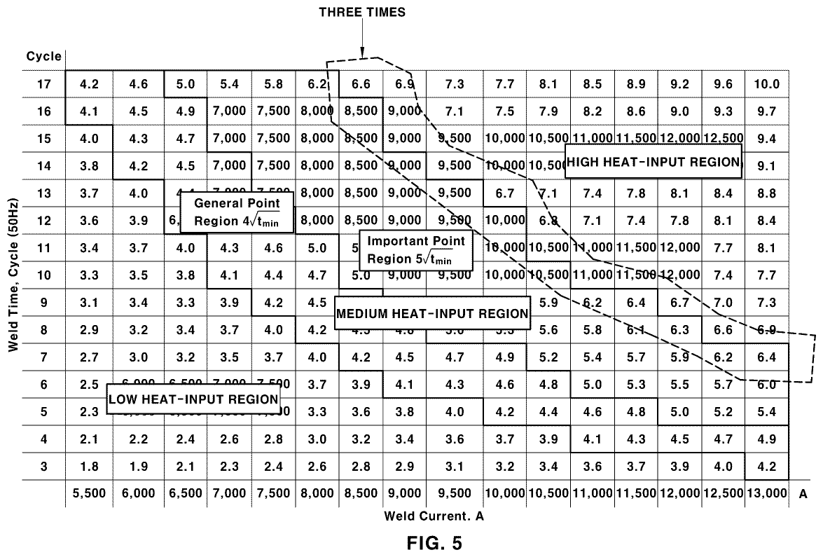

FIG. 4A shows height variation data when a current having optimum heat input is applied and FIG. 4B shows height variation data according to generation of spatter. Further, FIG. 5 shows the boundary value a high heat-input region and a medium heat-input region as a normal welding region.

As shown in the figures, FIG. 4A shows a height variation amount over time, which is a normal welding condition and shows data when the boundary heat input of the high heat-input range and the medium heat-input range is applied.

That is, it includes data in which a displacement gag measured through the encoder 100 increases over welding time and includes data continuously satisfying three times the condition that the time-height gradient is 0.1 or more. This means the state in which the boundary heat input between the high heat-input range and the medium heat-input range shown in FIG. 5 is applied to the welding device 10.

Accordingly, this is data in which a welding process with normal quality is performed with optimum welding heat input applied and may include an algorithm continuously satisfying three time the condition that the time-height gradient is 0.1 or more.

In comparison, FIG. 4B shows data in which a height continuously decreases over time with generation of spatter.

As shown in the figure, the controller 200 performs current compensation for providing optimal heat input when a time-height gradient of −0.5 or less is continuously measured three times. That is, the controller 200 determines a state in which spatter has been generated when the welding displacement gradient is smaller than zero.

When a displacement gradient is measured over the number of times set in the controller 200, generation of spatter is determined and the current value that is applied to the welding device 10 is decreased. This means the condition inside the block diagram shown in FIG. 4B.

Thereafter, the displacement gradient of the welding position is larger than zero in accordance with the compensated current value, which is a non-spatter generation condition, and the displacement gradient has a value larger than zero after 55 index time.

As described above, as shown in FIG. 3, the present disclosure can perform down compensation of a current value in correspondence to a spatter generation condition and can provide target heat input with a displacement gradient larger than 0 to the welding device. It is possible to improve the weld quality through this compensation.

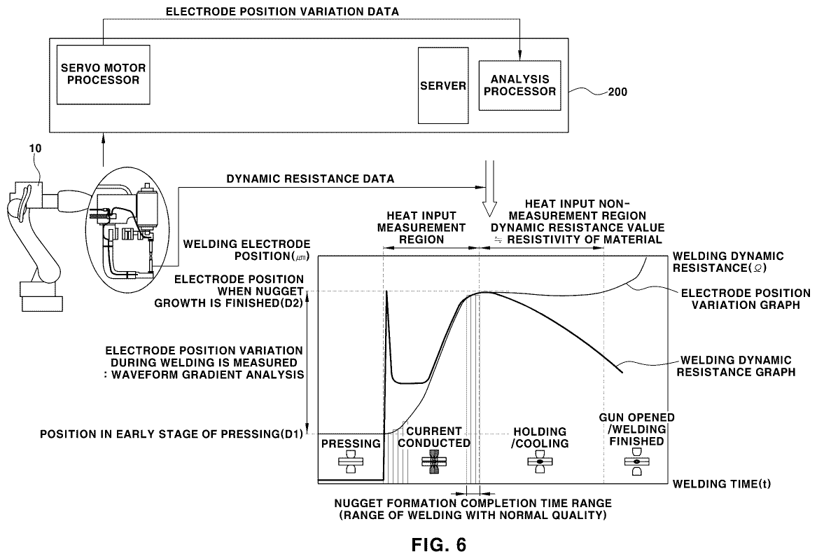

FIG. 6 shows a step of determining weld quality through a step of comparing optimum target heat input with actual welding heat input actually applied to the welding device after the optimum target heat input is applied.

This is a step of determining the quality of welding by comparing calculated optimum target heat input shown in FIG. 2 and actual welding heat input that is applied to the welding device 10.

In an embodiment of the present disclosure, the encoder 100 can determine height variation between electrodes in real time while welding is performed. Accordingly, it is possible to determine the formation completion time of nuggets. More preferably, the controller 200 can determine the point in time at which the height variation amount measured through the encoder 100 is close to zero as a nugget formation time, and can measure variation of dynamic resistance that is applied for the time for which nuggets are formed. Accordingly, it is possible to calculate actual welding heat input that is actually manifested by the welding device 10 through dynamic resistance and an applied current value until the formation completion time of nuggets.

Further, in an embodiment of the present disclosure, the controller 200 can measure height variation between electrodes in accordance with a time range through the encoder 100. The controller 200 can calculate actual welding heat input that is applied to the welding device 10 by performing a definite integral of an applied current and calculated dynamic resistance on the basis of the formation completion time of nuggets.

That is, dynamic resistance and an applied current value are calculated in correspondence to the time for which nuggets formed through welding is in a liquid state, and the actual welding heat input that is applied to the welding device 10 is calculated by performing a definite integral of the calculated dynamic resistance and current value in accordance with a corresponding time period.

The controller 200 compares the actual welding heat input calculated as described above with a predetermined range of target heat input. More preferably, the controller 200 determines whether the actual welding heat input corresponds to a range of 90% to 110% of target heat input, and determines the welding quality is satisfied when the actual welding heat input corresponds to the range of 90% to 110% of the target heat input.

On the other hand, when the actual welding heat input is out of the range of 90% to 110% of the target heat input, the controller 200 additionally compensates for the current value that is applied through welding device 10. Further, when the actual welding heat input is out of the range of 90% to 110% of the target heat input, the controller 200 can determine that welding poor welding has occurred and can provide an alarm to the user.

The specification provides examples of the present disclosure. Further, the description provides an embodiment of the present disclosure and the present disclosure may be used in other various combination, changes, and environments. That is, the present disclosure may be changed or modified within the scope of the present disclosure described herein, a range equivalent to the description, and/or within the knowledge or technology in the related art. The embodiment shows an optimum state for achieving the spirit of the present disclosure and may be changed in various ways for the detailed application fields and use of the present disclosure. Therefore, the detailed description of the present disclosure is not intended to limit the present disclosure in the embodiment. Further, the claims should be construed as including other embodiments.

What is claimed is:

1. A method for spot welding, the method comprising:
applying, by a controller, a preset welding heat input to a welding device;
applying, by the controller, the preset welding heat input to a welding position by moving the welding device;
measuring, by an encoder, a height variation of the applied welding position;
calculating, by the controller, an optimum target heat input by comparing a real-time height variation of the welding position measured through the encoder and a gradient set in the controller; and
determining, by the controller, weld quality by comparing the calculated optimum target heat input and an actual welding heat input.

2. The method of claim 1, wherein the controller applies the preset welding heat input in correspondence to a welding base material positioned at the welding device.

3. The method of claim 1, wherein the controller calculates the optimum target heat input by compensating for a current value that is applied to the welding position.

4. The method of claim 1, wherein the preset welding heat input is calculated based on existing data stored in accordance with completion of welding.

5. The method of claim 1, further comprising:
in providing the optimum target heat input,
determining whether a height variation gradient of the welding position is larger than a set gradient without spatter;
increasing a current value that is applied to the welding device when the height variation gradient of the welding position is larger than the set gradient without spatter;
determining whether the eight variation gradient of the welding position is a set gradient with spatter in accordance with the increased current value; and
setting welding heat input including a first margin value in the increased current value when the height variation gradient of the welding point is the set gradient with spatter or less.

6. The method of claim 1, further comprising:
in providing the optimum target heat input,
determining whether a height variation gradient of the welding position is a set gradient with spatter or less;
decreasing a current value that is applied to the welding device when the height variation gradient of the welding position is a set gradient with spatter or less;
determining whether height variation of the welding position is larger than a set gradient without spatter in accordance with the decreased current value; and
setting welding heat input including a second margin value in the decreased current value when the height variation of the welding position is larger than a set gradient.

7. The method of claim 1, further comprising:
in determining the weld quality,
comparing a range set on the basis of the optimum target heat input and the actual welding heat input by the controller; and
compensating a current value that is applied to the welding device when the actual welding heat input is out of the set range.

8. The method of claim 7, further comprising:
measuring a height variation of the welding position during welding through the encoder;
measuring a formation completion time of nuggets in correspondence to a position where the measured height variation of the welding position is maximum; and
calculating an actual applied heat input on the basis of the measured formation completion time of nuggets.

9. The method of claim 8, comprising:
in the calculating the actual applied heat input on the basis of the measured formation completion time of nuggets,
calculating heat input actually applied to the welding position on the basis of welding dynamic resistance, a current that is applied to the welding device, and the formation completion time of nuggets that are calculated on the basis of a voltage and a voltage drop amount detected in welding;
determining whether the actually applied heat input is within a normal range; and
determining poor quality when the actually applied heat input is out of the normal range.

10. The method of claim 8, comprising,
in calculating the actual welding heat input,
calculating actual welding heat input applied to the welding device by performing a definite integral of an applied current and calculated dynamic resistance on the basis of the formation completion time of nuggets by the controller.

11. The method of claim 1, wherein, in the providing of optimum target heat input by compensation for a current value that is applied to the welding position by comparing height variation of the welding position measured through the encoder and a gradient set in the controller,
the gradient is set through a machine learning algorithm of an analysis processor.

12. The method of claim 1, further comprising,
in calculating the optimum target heat input,
storing a β peak value of calculated dynamic resistance and the calculated target heat input in the controller.

13. A device for spot welding, the device comprising:
a welding device;
a controller configured to apply a preset welding heat input to the welding device and at a welding position by moving the welding device; and
an encoder configured to measure a height variation of the applied welding position;
wherein the controller is configured to calculate an optimum target heat input by comparing a real-time height variation of the welding position measured through the encoder and a gradient set in the controller; and
wherein the controller is configured to determine a weld quality by comparing the calculated optimum target heat input and an actual welding heat input.

14. The device of claim 12, wherein the controller applies the preset welding heat input in correspondence to a welding base material positioned at the welding device.

15. The device of claim 12, wherein the controller calculates the optimum target heat input by compensating for a current value that is applied to the welding position.
